(19) United States
(12) Patent Application Publication
(10) Pub. No.: US 2025/0163315 A1
(43) Pub. Date: May 22, 2025

(54) MATERIALS AND COMPOSITIONS FOR RESERVOIR STIMULATION TREATMENT

(71) Applicant: Swellfix UK Limited, Westhill, Aberdeenshire (GB)

(72) Inventors: Li JIANG, Katy, TX (US); Suzanne STEWART, Cypress, TX (US); Jonathan ABBOTT, Aberdeen (GB)

(73) Assignee: Swellfix UK Limited, Westhill, Aberdeenshire (GB)

(21) Appl. No.: 18/841,845

(22) PCT Filed: Feb. 28, 2023
(86) PCT No.: PCT/GB2023/050447

§ 371 Date: Aug. 27, 2024

(30) Foreign Application Priority Data
Feb. 28, 2022 (GB) 2202750.2

(51) Int. Cl. C09K 8/76; C09K 8/90

(52) U.S. Cl. CPC C09K 8/76; C09K 8/90; C09K 2208/08; C09K 2208/20

(57) ABSTRACT

A composition for stimulating a wellbore, subterranean formation or reservoir, comprises a stimulating fluid such as an acid; a rate modulator configured to reduce or decrease the rate of reaction between the stimulating fluid and the wellbore, subterranean formation or reservoir; and a dispersant. The composition may be suitable for use in acid treatment, e.g. acid stimulation, of a wellbore, subterranean formation or reservoir.

### FIELD OF THE INVENTION

The present invention relates to compositions and methods for treating, e.g. stimulating, a wellbore, subterranean formation or reservoir. In particular, but not exclusively, the invention relates to compositions and methods for acid stimulating a wellbore, subterranean formation or reservoir.

### BACKGROUND

Hydrocarbon fluids such as oil and natural gas are produced from a subterranean geologic formation, commonly referred to as a reservoir, by drilling a well that penetrates the hydrocarbon-bearing formation. Once a wellbore is drilled, various components forming part of a well completion assembly may be installed in order to control and enhance production of the various fluids of interest from the reservoir.

Stimulation operations may be performed to facilitate production of hydrocarbon fluids from subsurface formations by increasing the net permeability of a reservoir. There are two main stimulation techniques: matrix stimulation and fracturing.

Acidizing, that is treatment with an acid stimulation fluid, is primarily used to achieve two distinct objectives: either to remove damage in a well/reservoir or to stimulate a well/reservoir to increase matrix reservoir flow. Consequently, there are two types of acid treatments that are related to injection rates and pressures: treatment involving injection rates resulting in pressures below fracturing pressure is termed matrix acidizing, while treatment involving injection rates above fracturing pressure is termed fracture acidizing. It will be noted that acidic treatment fluids may also be used to clean out wellbores to facilitate the flow of desirable hydrocarbons, or may be used in diversion processes.

In matrix acidizing, the aim is to improve or to restore the permeability of the region near the wellbore (typically a radius of 8 to 24 inches) without fracturing the producing formation. In a matrix acidizing procedure, an aqueous acidic treatment fluid is introduced into a subterranean formation via a wellbore therein under pressure so that the acidic treatment fluid flows into the pore spaces of the formation and reacts with (e.g., dissolves) the acid-soluble materials therein. As a result, the pore spaces of that portion of the formation are enlarged, and the permeability of the formation increases subsequently. The increase in permeability will decrease the pressure drop associated with the production or the injection of fluids by enlargement of the pore throats or by removal of formation permeability damage caused by drilling or completion fluids. The increase in production gained by a matrix acid procedure will depend on the reservoir pressure and whether the formation permeability next to the wellbore is damaged. In an undamaged formation, the production increase from a matrix acidizing job is very low. However, if the formation permeability near the wellbore is reduced as a result of damage from natural causes or completion fluids, the production can be increased considerably (up to 100 times) by removing the damage. In a producing well, a zone of damaged permeability near the wellbore chokes the converging radial flow and can decrease production severely. Not all causes of permeability damage are acid-soluble. For example, sulfate scales induced permeability damage are not acid-soluble. For example, sulfate scales, paraffin, tar, water blocks, and most emulsions are largely unaffected by mineral or organic acids. These problems require special treatment in addition to (or instead of) acid treatments. Typically, matrix stimulation is accomplished, in carbonates and sandstones, by injecting a treatment fluid (e.g., acid or solvent) to dissolve and/or disperse materials that impair well production. Specifically, matrix stimulation treatment may be performed (1) by injecting chemicals into the wellbore to react with and dissolve the damage and (2) by injecting chemicals through the wellbore and into the formation to react with and dissolve small portions of the formation to create alternative flow path for the hydrocarbon (e.g., instead of removing the damage, redirecting the migrating oil around the damage). In carbonate formations, which contains approximately two-third of the world's remaining oil reserves and are intrinsically heterogeneous with complex porosity and permeability profiles, plus irregular flow paths, the goal of matrix stimulation is to create new, unimpaired flow channels from the formation to the wellbore. Matrix stimulation, typically called matrix acidizing when the stimulation fluid is an acid, is generally used to treat the near-wellbore region. In a matrix acidizing treatment, the acid used (for example hydrochloric acid for carbonates, and hydrochloric acid plus hydrofluoric acid mixture for sandstones) is injected at a pressure low enough to prevent formation fracturing.

Matrix acid treatments typically use from 15 to 200 gallons of acid per foot (length) of producing formation. The acid is injected at pressures less than the pressure that will cause the formation to fracture. Hydrochloric acid in strengths from 5 to 28% is commonly used to remove carbonate and iron scales and as a pre-flush for HCl/hydrofluoric acid, in case of sandstone reservoir stimulation. To treat clay damage and to remove drilling mud, HF at a strength of 1.5 to 3% is used in combination with HCl.

Fracture acidizing is a stimulating treatment for carbonate formations in which acid-etched channels serve as high-conductivity flow paths along the face of the fracture. In fracture acidizing procedures, on the other hand, one or more fractures are produced in the formation(s) and an acidic treatment fluid is introduced into the fracture(s) at the fracturing pressure, to etch flow channels therein. Fracturing involves injecting chemicals through the wellbore and into the formation at pressures sufficient to fracture the formation, thereby creating a large flow channel network through which hydrocarbon can move more readily from the formation and into the wellbore.

Analogous to hydraulic fracturing treatment which breaks the formation with pump- and/or hydrostatically-produced pressures, the pressure of the acid fracturing fluid produces cracks in the formation along which the acid flows. The acid also reacts with the carbonate formation, removes part of this reactive rock dependent on the relative reaction rates of different carbonates with acid at the given temperature and pumping rate, and leaves channels along the face of the crack. For the channels to form, the formations tend to be limestone, dolomite, or chalk with a total carbonate content of at least 60%. The increase in productivity that is expected from acid fracturing treatment depends on many of the same conditions as proppant fracturing, including permeability, pressure, viscosity of produced fluid, and length and conductivity of the fracture. In undamaged, low-permeability formations with equal reservoir pressures, acid fracturing will increase production far more than matrix acidizing. Higher-viscosity fluids (such as oil) can flow much more easily down the high-conductivity acidizing fracture than through a high-permeability matrix. The length of an acidized fracture is limited, however, by the rate at which acid is spent on the carbonate and by the increasing fluid leak-off. The acid-etched fracture will extend only as far as unspent acid has penetrated. The acid reactivity is a function of several variables, the most important of which are temperature and the area/volume ratio (i.e., the ratio of the area of reactive formation in the matrix or fracture to the volume of acid in contact with that area). The higher this ratio (more surface area), the faster the acid will be spent (penetration of live acid is reduced). In the formation matrix of a low-permeability carbonate, the area/volume ratio can be over 30,000:1. In a hydraulically created fracture, the value will be in the range of 100:1, characteristic of the formation or fracture conditions. Fluid lost from the acid in the fracture also decreases the possible fracture length because less fluid remains to extend the potential fracture length. Leak-off from the acid volume in the main fracture is increased by the reaction of the acid, which increases the permeability of the leak-off zones. Typically, hydrochloric acid at 15 to 28% strength is used in acid fracturing at volumes of 100 to 500 gallons of acid per foot of producing formation.

One commonly used aqueous acidic treatment fluid comprises hydrochloric acid. Other commonly used acids for acidic treatment fluids include hydrofluoric acid, acetic acid, formic acid, citric acid, lactic acid, ethylenediaminetetraacetic acid (“EDTA”), glycolic acid, alkylsulfonic acid, sulfamic acid, and derivatives or combinations thereof.

By example, the reaction between hydrochloric acid and calcite can be described by equation (1):

$$2 HCl + {CaCO}_{3} \to {CaCl}_{2} + {H}_{2} O + {CO}_{2} ↑ \qquad ( 1 )$$

Similarly, the reaction between hydrochloric acid and dolomite-another characteristic carbonate—can be described by equation:

$$4 HCl + {CaMg ( {CO}_{3} )}_{2} \to {CaCl}_{2} + {MgCl}_{2} + 2 {H}_{2} O + 2 {CO}_{2} ↑ \qquad ( 2 )$$

Acid treatments suffer from a number of problems, including in particular limited radial penetration, and severe corrosion to pumping and wellbore tubing. Both effects are associated with the higher-than-desired reaction rate (or spending rate) of the acid, such as HCl, toward the formation surface, in particular at higher temperatures. For example, mineral acids (particularly at elevated reservoir temperatures) exhibit an excessive reaction rate toward carbonate minerals (either calcite (CaCO₃) or dolomite CaMg(CO₃)₂).

Limitations on radial penetration occur because as soon as the acid, in particular a mineral/inorganic acid, is introduced into the formation or wellbore, it reacts instantaneously with the formation matrix and/or the wellbore scaling. In practice, the dissolution is so quick that the injected acid is spent by the time it reaches no more than a few inches beyond the wellbore, thus preventing the generation of fracture length into the formation.

Numerous approaches have been used to delay the acid reactivity, mainly via physical means.

For example, it is common in oilfield operations to design retarded acid systems. This involve, for example, encapsulating inorganic acid into shells of polymer gel (linear or crosslinked) or light oils in the presence of a surfactant and/or of a chelating agent. Alternatively, mineral acid can be blended into surfactant-generating foams, shielding the acid from the external environment.

Other attempts involve blending mineral acid with an organic acid to modulate its reactivity. For example, organic acids (e.g., formic acid, acetic acid and/or lactic acid and its polymeric version) are sometimes used, especially at higher temperatures, to address limitations on radial penetration since organic acids react more slowly than mineral acids.

Each of these options has associated drawbacks and is an imperfect solution to limited radial penetration.

Examples of such techniques for mineral acid modification disclosed in the prior art (all of which are incorporated herein by reference) include:
Using amine-containing ligands, as disclosed for example in U.S. Pat. No. 9,476,287;
Using monoethanolamine, as disclosed for example in U.S. Pat. No. 10,822,535;
Using an amino acid including glycine (as disclosed for example in U.S. Pat. No. 9,920,606), or lysine (as disclosed for example in U.S. Pat. No. 10,982,133 or U.S. Pat. No. 11,168,246);
Using metal chloride, as disclosed for example in U.S. Pat. No. 10,378,325;
Using a gelled or emulsified acid, as disclosed for example in U.S. Pat. No. 10,428,165 or U.S. Pat. No. 10,472,561.

Thus, an ongoing need exists for improved stimulation operation compositions and methods of utilizing same.

It is an object of the invention to address and/or mitigate one or more problems associated with the prior art.

It is an object of the invention to provide an improved composition and/or method for stimulating a wellbore, subterranean formation or reservoir.

### SUMMARY

According to a first aspect there is provided a composition capable of stimulating a wellbore, subterranean formation or reservoir, the composition comprising:
a stimulating fluid;
a rate modulator; and
a dispersant.

The stimulating fluid may comprise or may be an acid. In such instance, the composition may be an acid treatment composition. The composition may be suitable for use in acid treatment, e.g. acid stimulation, of a wellbore, subterranean formation or reservoir.

The acid may comprise or may consist of a mineral acid. The acid, e.g. mineral acid, may comprise hydrochloric acid (HCl) and/or hydrofluoric acid (HF).

Typically, the composition may comprise hydrochloric acid at a concentration of about 5 to 28 wt %. The composition may comprise or may further comprise hydrofluoric acid at a concentration of about 1-6, e.g. 3-6 wt %. The composition may comprise a mixture of HCl and HF in a ratio of about 4:1 to 9:1.

The acid may comprise, may further comprise, or may consist of an organic acid. The acid, e.g. organic acid, may comprise acetic acid, formic acid, citric acid, lactic acid, ethylenediaminetetraacetic acid (“EDTA”), glycolic acid, alkylsulfonic acid, sulfamic acid, and derivatives or combinations thereof.

The term “derivative” is defined herein to include any compound that is made from one of the listed compounds, for example, by replacing one atom in the listed compound with another atom or group of atoms, rearranging two or more atoms in the listed compound, ionizing one of the listed compounds, or creating a salt of one of the listed compounds.

The rate modulator may be configured to modulate the rate of reaction between the stimulating fluid, e.g. the acid, and the wellbore, subterranean formation or reservoir. Advantageously, the rate modulator may be configured to reduce or decrease the rate of reaction between the stimulating fluid, e.g. the acid, and the wellbore, subterranean formation or reservoir. Thus, the rate modulator may be configured to slow down a/the chemical reaction between the stimulating fluid, e.g. the acid, and the material of the wellbore, subterranean formation or reservoir.

The rate modulator may comprise or may consist of a lignosulfonate or a modified lignosulfonate, e.g. a lignosulfonate salt such as a calcium, sodium or magnesium salt thereof.

Lignosulfonates may typically be formed as by-products from the production of wood pulp using sulfite pulping. Lignosulfonates may typically be aqueous soluble anionic polymers, and may have generally a wide molecular weight distribution, typically in the range of about 500 to about 200,000 Daltons.

The rate modulator, e.g. lignosulfonate, may be present at a concentration of about 0.01-90 wt %, e.g. about 0.05-50 wt %, typically about 0.1-25 wt %, based on the total weight of the composition. It will be understood that the concentration of the rate modulator in the composition may be selected based on the particular use and conditions, for example based on rock type or lithology, formation temperature, or the like.

Advantageously, the use of a lignosulfonate may allow the use of an environmentally-friendly material which is sustainable and biodegradable. In addition, the use of a lignosulfonate may advantageously offer potential functionality of in-situ H₂S scavenging.

The dispersant may comprise or may consist of microfibrillated cellulose (MFC).

Microfibrillated cellulose (MFC) will be herein understood to refer to cellulose fibers that have been subjected to a fibrillation process. Typically, MFC is obtained via a mechanical treatment resulting in an increase of the specific surface and a reduction of the size of cellulose fibers, in terms of cross-section (diameter) and/or length. Typically, the resulting fibrils of MFC may have a diameter in the nanometer range and a length in the micrometer range. The fibrillation process used to make MFC separates the cellulose fibers into a three dimensional network of microfibrils with a large surface area. The obtained fibrils are typically much smaller in diameter compared to the original fibers, and typically form a three-dimensional network or web-like structure.

Typically, the MFC fibers or fibrils may have a diameter of up to 100 nm, e.g. in the range of about 0.1-100 nm, e.g. 0.1-75 nm, e.g. about 1-75 nm, typically about 1-50 nm.

Typically, the MFC fibers or fibrils may have a length of about 1-100 μm, e.g. about 10-75 μm, e.g. about 20-50 μm.

Typically, the MFC fibers or fibrils may have a length to diameter ratio of about 10 to 10,000, e.g. about 100 to 5,000, e.g. about 250 to 1000.

The dispersant, e.g. microfibrillated cellulose, may be present at a concentration of or in an amount of about 0.01-2 wt %, e.g. about 0.05-1 wt %, typically about 0.1-0.5 wt %, based on the total weight of the composition. It will be understood that the concentration or amount of the dispersant in the composition may be selected based on the particular use and conditions, for example based on rock type or lithology, or formation temperature.

Advantageously, the use of microfibrillated cellulose may allow the use of an environmentally-friendly material which is sustainable and biodegradable. In addition, the use of microfibrillated cellulose may help maintain a single phase formulation of both the composition, e.g. treatment fluid, and the post-treatment mixture. Advantageously, microfibrillated cellulose may confer to the composition shear thinning properties (thus allowing the composition to be pumped through the wellbore with little or negligible friction resistance, preventing or minimizing the risk of phase separation and/or of loss of undesirable residues in the formation), and/or may confer fluid loss control functionality. These properties were found to be currently not obtainable using other types of fibrillated cellulosic materials, such as nanofibrillated cellulose (NFC). For example, MFC may exhibit unique properties particularly useful in the present application, including the extent of bundle assemblies of individual fibrils, fibril length and aspect ratio ranges, significantly higher levels of water retention, stability and rheological profiles in extremely low pH media, that are not available with other chemical and/or other cellulosic variants.

Thus, in an embodiment, the composition may comprise:
a stimulating fluid, wherein the stimulating fluid comprises or consists of an acid;
a rate modulator, wherein the rate modulator comprises or consists of a lignosulfonate or a modified lignosulfonate; and
a dispersant, wherein the dispersant comprises or consists of microfibrillated cellulose.

Advantageously, the combination of ingredients of the present invention provides a composition suitable for stimulation operations, which composition may be environmentally-friendly, may exhibit shear thinning properties (thus allowing the composition to be pumped through the wellbore with little or negligible friction resistance, preventing or minimizing the risk of phase separation and/or of loss of undesirable residues in the formation), and/or may exhibit fluid loss control functionality. Other potential advantages of the present composition include improved mixing properties with commonly used gelling agents, potential capability of dispersing in any brine over a wider range of pH levels, potential relative ease of additive hydration in the presence of certain common contaminants, potential capability of compatibility with formation brine (potentially saving time and cost), and potential ability to be directly blended into a mineral acid.

The composition may comprise or may further comprise a base fluid, preferably an aqueous base fluid. The base fluid may comprise fresh water, salt water, seawater, a brine (e.g., a saturated salt-water brine or a formation brine), or a combination thereof.

The choice of aqueous base fluid and acid may be selected vis-a-vis the other, among other reasons, so that the proper synergistic effect is achieved.

The composition may comprise one or more additives.

The composition may comprise a fluid loss additive. Whilst the inventors have discovered that the presence of microfibrillated cellulose in the composition may provide advantageous fluid loss properties to the composition, it may be desirable in some instances to include one or more fluid loss additives in order to fine-tune the properties of the composition.

Advantageously, a fluid loss additive may be selected to be compatible with the composition, e.g. stimulation composition, of the present invention.

The fluid loss additive may comprise one or more compounds selected from the list consisting of starches, silica flour, and diesel dispersed in a fluid.

The fluid loss additive may comprise a degradable material, which may include one or more compounds, e.g. polymers, selected from the list consisting of polysaccharides such as dextran or cellulose; chitins; chitosans; proteins; aliphatic polyesters; poly(lactides); poly(glycolides); poly(glycolide-co-lactides); poly(ε-caprolactones); poly(3-hydroxybutyrates); poly(3-hydroxybutyrate-co-hydroxyvalerates); poly(anhydrides); aliphatic poly(carbonates); poly(orthoesters); poly(amino acids); poly(ethylene oxides); poly(phosphazenes); derivatives thereof; or combinations thereof.

The fluid loss additive may be present in the composition at a concentration of about 5 to 100 pounds per 1000 gallons, e.g. about 10 to about 50 pounds per 1000 gallons, of the composition.

According to a second aspect there is provided a composition capable of stimulating a wellbore, subterranean formation or reservoir, the composition comprising:
an stimulating fluid, wherein the stimulating fluid comprises or consists of an acid;
a rate modulator, wherein the rate modulator comprises or consists of a lignosulfonate or a modified lignosulfonate; and
a dispersant, wherein the dispersant comprises or consists of microfibrillated cellulose.

According to a third aspect there is provided a composition for treating a wellbore, subterranean formation or reservoir, the composition comprising:
a treatment fluid; and
a dispersant, wherein the dispersant comprises or consists of microfibrillated cellulose.

Advantageously, the use of microfibrillated cellulose may allow the use of an environmentally-friendly material which is sustainable and biodegradable. In addition, the use of microfibrillated cellulose may help maintain a single phase formulation of both the composition, e.g. treatment fluid, and the post-treatment mixture.

Advantageously, microfibrillated cellulose may confer to the composition shear thinning properties (thus allowing the composition to be pumped through the wellbore with little or negligible friction resistance, preventing or minimizing the risk of phase separation and/or of loss of undesirable residues in the formation), and/or may confer fluid loss control functionality.

The treatment fluid may be or may comprise a stimulation fluid, e.g. an acid.

The composition may further comprise a rate modulator, for example a lignosulfonate or a modified lignosulfonate.

According to a fourth aspect, there is provided a method of treating a wellbore, subterranean formation or reservoir, the method comprising injecting in the wellbore, subterranean formation or reservoir a composition according to the first, second or third aspect.

The method may comprise stimulating the wellbore, subterranean formation or reservoir.

The method may comprise performing acid stimulation of the wellbore, subterranean formation or reservoir, e.g. matrix acidizing or acid fracturing.

The method may comprise dissolving filter cake and/or gravel packing.

The features described in relation to any aspect of the invention may equally apply to any other aspect and, merely for brevity, are not repeated. For example, features described in relation to compositions can apply in relation to methods, and vice versa.

### BRIEF DESCRIPTION OF DRAWINGS

The invention will be described with reference to the accompanying drawings, in which:

FIG. 1 shows the results of an amplitude sweep test for 0.5 wt % Exilva™ MFC in DI water, compared to the same amount of other cellulose or saccharide derivatives including HEC, CMC, guar gum and xanthan gum.

FIG. 2 shows the results of a shear viscosity test for the same components as those of FIG. 1, depicting viscosity against shear rate.

FIG. 3 is a graph illustrating the results of a coreflood test, showing pore volume breakthrough vs injection rate.

### DETAILED DESCRIPTION

As explained above, the present inventors have discovered improved compositions for treating a wellbore, subterranean formation or reservoir.

Typically, the composition comprises a treatment fluid and a dispersant.

Advantageously, the dispersant may comprise or may consist of microfibrillated cellulose.

Advantageously, the use of microfibrillated cellulose may allow the use of an environmentally-friendly material which is sustainable and biodegradable. In addition, the use of microfibrillated cellulose may help maintain a single phase formulation of both the composition, e.g. treatment fluid, and the post-treatment mixture. Advantageously, microfibrillated cellulose may confer to the composition shear thinning properties (thus allowing the composition to be pumped through the wellbore with little or negligible friction resistance, preventing or minimizing the risk of phase separation and/or of loss of undesirable residues in the formation), and/or may confer fluid loss control functionality.

When the treatment involves stimulating the wellbore, subterranean formation or reservoir, the composition comprises:
a stimulating fluid;
a rate modulator; and
a dispersant.

The stimulating fluid may comprise or may be an acid. In such instance, the composition may be an acid treatment composition. The composition may be suitable for use in acid treatment, e.g. acid stimulation, of a wellbore, subterranean formation or reservoir.

The acid may comprise or may consist of a mineral acid. The acid, e.g. mineral acid, may comprise hydrochloric acid (HCl) and/or hydrofluoric acid (HF).

Typically, the composition may comprise hydrochloric acid at a concentration of about 5 to 28 wt %. The composition may comprise or may further comprise hydrofluoric acid at a concentration of about 1-6, e.g. 3-6 wt %. The composition may comprise a mixture of HCl and HF in a ratio of about 4:1 to 9:1.

The acid may comprise or may consist of an organic acid. The acid, e.g. organic acid, may comprise acetic acid, formic acid, citric acid, lactic acid, ethylenediaminetetraacetic acid (“EDTA”), glycolic acid, alkylsulfonic acid, sulfamic acid, and derivatives or combinations thereof.

The term “derivative” is defined herein to include any compound that is made from one of the listed compounds, for example, by replacing one atom in the listed compound with another atom or group of atoms, rearranging two or more atoms in the listed compound, ionizing one of the listed compounds, or creating a salt of one of the listed compounds.

The concentration and type of acid selected may be based upon the function of the acid (e.g., scale removal, fracture acidizing, matrix acidizing, removal of fluid loss filter cakes and pills, and the like), compatibility with crude oil, and/or mineralogy and/or temperature of the formation. Certain concentrations of acids, such as formic acid, may have a tendency to form precipitates upon spending.

The rate modulator may be configured to modulate the rate of reaction between the stimulating fluid, e.g. the acid, and the wellbore, subterranean formation or reservoir. Advantageously, the rate modulator may be configured to reduce or decrease the rate of reaction between the stimulating fluid, e.g. the acid, and the wellbore, subterranean formation or reservoir. Thus, the rate modulator may be configured to slow down a/the chemical reaction between the stimulating fluid, e.g. the acid, and the material of the wellbore, subterranean formation or reservoir.

The rate modulator may comprise or may consist of a lignosulfonate or a modified lignosulfonate, e.g. a lignosulfonate salt such as a calcium, sodium or magnesium salt thereof.

Lignosulfonates may typically be formed as by-products from the production of wood pulp using sulfite pulping. Lignosulfonates may typically be aqueous soluble anionic polymers, and may have generally a wide molecular weight distribution, typically in the range of about 500 to about 200,000 Daltons.

The rate modulator, e.g. lignosulfonate, may be present at a concentration of about 0.01-90 wt %, e.g. about 0.05-50 wt %, typically about 0.1-25 wt %, based on the total weight of the composition. It will be understood that the concentration of the rate modulator in the composition may be selected based on the particular use and conditions, for example based on rock type or lithology, formation temperature.

Advantageously, the use of a lignosulfonate may allow the use of an environmentally-friendly material which is sustainable and biodegradable. In addition, the use of a lignosulfonate may advantageously offer potential functionality of in-situ H₂S scavenging.

Lignosulfonates appropriate for the purpose of acting as a rate modulator can be defined by the extent of derivation from the lignin starting material, essentially a degree of sulfonation parameter as depicted in formula (3):

$$DS = \frac{{N}_{NaOH} {V}_{NaOH}}{{W}_{LS}} \qquad ( 3 )$$

where DS is the degree of sulfonation (mmol/g), N_{NaOH} the mole concentration of the NaOH standard solution (mmol/ml) used in the titration, consumed by a volume of V_{NaOH} (ml), W_{LS} the mass of the lignosulfonate material (g) used to make up the titration solution.

The DS value is typically estimated by first passing the lignosulfonate solution of known weight concentration through, in sequence, an anion exchange resin column for the purpose of removing residue inorganic acid, and a cation exchange resin column to converting lignosulfonate into corresponding lignosulfonic acid. The resultant acidic solution is then titrated by a sodium hydroxide standard solution, with the equivalence point being monitored by a potentiometer. The appropriate DS values are typically ranging from about 0.2 to about 5.0, such as from about 0.5 to about 4.0, for example, from about 0.8 to about 3.5.

Modified lignosulfonate may comprise or may consist of alkylated lignosulfonate.

Modified lignosulfonate may include lignosulfonates reacted with a base or salt, such as sodium hydroxide.

Modified lignosulfonates may include cations selected from the group consisting of ammonium cations, lithium cations, sodium cations, potassium cations, silver cations, calcium cations, magnesium cations, zinc cations, iron cations, copper cations, cobalt cations, manganese cations, nickel cations, titanium cations, aluminum cations, or combinations thereof.

An example of a modified lignosulfonate includes sodium lignosulfonate, which may be referred to as NBS.

Without wishing to be bound by theory, it is hypothesized that the mechanism involved in modulating the rate of reaction of an acid with a carbonate matrix may be based on two possible modes of interaction, namely:
(1) the abundant anionic moieties in lignosulfonate binding to the acidic protons and hence restricting their mobilities; and/or
(2) the resultant carbon dioxide forming polymer chains with lignosulfonate, catalyzed by the presence of newly liberated calcium cation, thus preventing the reaction equilibrium to be reached.

The dispersant may comprise or may consist of microfibrillated cellulose (MFC).

Microfibrillated cellulose (MFC) will be herein understood to refer to cellulose fibers that have been subjected to a fibrillation process. Typically, MFC is obtained via a mechanical treatment resulting in an increase of the specific surface and a reduction of the size of cellulose fibers, in terms of cross-section (diameter) and/or length. Typically, the resulting fibrils of MFC may have a diameter in the nanometer range and a length in the micrometer range. The fibrillation process used to make MFC separates the cellulose fibers into a three dimensional network of microfibrils with a large surface area. The obtained fibrils are typically much smaller in diameter compared to the original fibers, and typically form a three-dimensional network or web-like structure.

Typically, the MFC fibers or fibrils may have a diameter of up to 100 nm, e.g. in the range of about 0.1-100 nm, e.g. 0.1-75 nm, e.g. about 1-75 nm, typically about 1-50 nm.

Typically, the MFC fibers or fibrils may have a length of about 1-100 μm, e.g. about 10-75 μm, e.g. about 20-50 μm.

Typically, the MFC fibers or fibrils may have a length to diameter ratio of about 10 to 10,000, e.g. about 100 to 5,000, e.g. about 250 to 1000.

The dispersant, e.g. microfibrillated cellulose, may be present at a concentration of about 0.01-2 wt %, e.g. about 0.05-1 wt %, typically about 0.1-0.5 wt %, based on the total weight of the composition. It will be understood that the concentration of the dispersant in the composition may be selected based on the particular use and conditions, for example based on rock type or lithology, formation temperature.

Advantageously, the use of microfibrillated cellulose may allow the use of an environmentally-friendly material which is sustainable and biodegradable. In addition, the use of microfibrillated cellulose may help maintain a single phase formulation of both the composition, e.g. treatment fluid, and the post-treatment mixture. Advantageously, microfibrillated cellulose may confer to the composition shear thinning properties (thus allowing the composition to be pumped through the wellbore with little or negligible friction resistance, preventing or minimizing the risk of phase separation and/or of loss of undesirable residues in the formation), and/or may confer fluid loss control functionality.

Microfibrillated cellulose, also known as “reticulated” cellulose, “superfine” cellulose, or “cellulose nanofibrils”, among others, is a cellulose-based product whereby the cellulose fibers have been subjected to a fibrillation process. The fibrillation process typically includes a first step involving soaking and dispersing a pulp in water. Subsequently, the cellulose fibers are transformed into microfibrils using a process involving high shear forces. To create such shear forces, different methods can be used, including for example a high pressure homogenizer, grinding, cryocrushing, high intensity ultrasonication, or electrospinning.

Examples of such a fibrillation process for making MFC are described in U.S. Pat. No. 4,481,077 (Herrick), U.S. Pat. No. 4,374,702 (Turbak et al) and U.S. Pat. No. 4,341,807 (Turbak et al), which are all incorporated herein by reference. In particular, U.S. Pat. No. 4,374,702 (Turbak et al) describes a process for making MFC which involves passing a liquid suspension of cellulose through a small diameter orifice in which the suspension is subjected to a pressure drop of at least 3000 psig and a high velocity shearing action followed by a high velocity decelerating impact, and repeating the passage of said suspension through the orifice until the cellulose suspension becomes a substantially stable suspension. The process converts the cellulose pulp into microfibrillated cellulose without substantial chemical change of the cellulose starting material.

According to U.S. Pat. No. 4,374,702, microfibrillated cellulose has distinct properties vis-à-vis cellulose products not subjected to the mechanical treatment disclosed in U.S. Pat. No. 4,374,702. In particular, the microfibrillated cellulose described in these documents has reduced length scales (diameter, fiber length), improved water retention and adjustable viscoelastic properties.

Other types of cellulose fiber exist, for example, nanofibrillated cellulose (NFC), or microcrystalline cellulose, which are different from MFC in their dimensions, structures and/or properties.

Nanofibrillated cellulose can be defined as a material having a length dimension of 100 nm or less with very high specific area and high porosity. CNF is made of nanosized cellulose fibrils having a high aspect ratio (length to width ratio). Typical CNF fibril widths may be in the region of 5-20 nm with a wide range of lengths, typically several μm, typically less than 10 μm or less than 5 μm.

In microcrystalline cellulose, the amorphous, accessible regions of the cellulose are either degraded or dissolved away leaving the less accessible crystalline regions as fine crystals a few tens of microns in size. In preparing microcrystalline cellulose, it is necessary to destroy a significant part of the cellulose to produce the final product, and consequently, it is quite expensive. In addition, most of the desirable amorphous reactive part of the fiber is removed and destroyed leaving only the microcrystals which are primarily surface reactive.

For microfibrillated cellulose, optical microscopic imaging under appropriate magnification reveals the morphology at the ends of the fibrils as well as the fibril lengths and the degree of entanglements of fibrils in the MFC network structure, thus allowing for conclusions on how the morphology of the fibrils on that level determines the macrostructure of the MFC material, which in turn is responsible for the physical properties as described in the present disclosure.

Such a magnification of was chosen to have a reasonable number of fibrils in the given area of the image to be counted, at the given concentration of the MFC material. By means of optical microscopy, individual fibrils or fibril bundles or fibre fragments with cross sectional diameter larger than approximately 200 nm can be studied. Fibrils with cross-sectional diameter below this range cannot be fully resolved or seen, but will be present, coexisting with the fibrils or fibril bundles that can be resolved by optical microscopy as described herein.

The (micro)fibrils and their morphology is/are described, throughout the present disclosure, exclusively based on structures discernible at the microscopic level, i.e. as discernible by means of optical microscopy as described herein. The skilled person understands that additional structural and/or morphological information may be discernible at a higher magnification or by use of other methods, in particular by methods that have a better resolution.

In principle, any type of MFC materials can be used in accordance with the present invention, as long as the fiber bundles as present in the original cellulose pulp are sufficiently disintegrated in the process of making MFC so that the average diameter of the resulting fibers/fibrils is in the nanometer-range and therefore more surface of the overall cellulose-based material has been created, vis-à-vis the surface available in the original cellulose material. MFC may be prepared according to any of the processes known to the skilled person.

In accordance with the present invention, there is no specific restriction in regard to the origin of the cellulose, and hence of the MFC. In principle, the raw material for the cellulose microfibrils may be any cellulosic material, in particular wood, annual plants, cotton, flax, straw, ramie, bagasse (from sugar cane), suitable algae, jute, sugar beet, citrus fruits, waste from the food processing industry or energy crops or cellulose of bacterial origin or from animal origin, e.g. from tunicates.

In principle, the MFC in accordance with the present invention may be unmodified in respect to its functional groups or may be physically modified or chemically modified, or both.

Chemical modification of the surface of the cellulose microfibrils may be achieved by various possible reactions of the surface functional groups of the cellulose microfibrils and, more particularly, of the hydroxyl functional groups, preferably by: oxidation, carboxylation, carboxymethylation, silylation reactions, etherification reactions, condensations with isocyanates, alkoxylation reactions with alkylene oxides, or condensation or substitution reactions with glycidyl derivatives. Chemical modification may take place before or after the defibrillation step, preferably after the defibrillation step since the functional groups to be modified (in particular-OH groups) are sterically better available after defibrillation.

Also, the MFC is unmodified MFC or is physically modified MFC, preferably unmodified MFC. Also preferably, the MFC does not comprise a lignin coating.

“Unmodified MFC”, as referred to herein, relates to MFC that comprises only “naturally occurring functional groups”. The term “naturally occurring functional groups” refers to functional groups that are already present (or, more precisely, have already been present) when the cellulose is present in the cellulosic material from which the MFC is derived (e.g. wood, annual plants, cotton, flax, straw, ramie, bagasse (from sugar cane), suitable algae, jute, sugar beet, citrus fruits, and so on) and to functional groups that are introduced (or, more precisely, have been introduced) by means of a pulping process such as sulfite pulping or Kraft pulping.

Preferably, the MFC is derived from a pulping process and subsequent defibrillation and has not been subjected to a post-pulping chemical functionalization step. As referred to herein, a “post-pulping chemical functionalization step”, is a dedicated step of treating MFC obtained from a pulping process with another reagent in a chemical reaction such that the MFC functional groups that are present before said chemical reaction (mostly —OH groups) are converted into different functional groups.

The term “dedicated” in the expression “dedicated step of treating MFC” means that the step of treating MFC is a deliberate step that is performed with the aim of modifying the functional groups. Thus, e.g., mere oxidation in ambient air over time (which occurs more or less “accidentally”) is not a chemical functionalization step within the meaning of the present application. On the other hand, oxidation by means of a dedicated treatment, e.g. an ozone treatment in an ozone generator, is a chemical functionalization step within the meaning of the present application.

In addition, the “post-pulping chemical functionalization step” (which has preferably not been applied to the MFC of the present invention) is an oxidation reaction, a carboxylation reaction, a carboxymethylation reaction, a reaction of adding cationic functional groups, and a reaction of grafting a second polymer onto the MFC.

It is also preferred that the MFC has not been subjected to a (dedicated) oxidation reaction, a carboxylation reaction, a carboxymethylation reaction, a reaction of adding cationic functional groups, and a reaction of grafting a second polymer onto the MFC.

Furthermore, the MFC has not been subjected to a chemical functionalization step after the defibrillation step. That “chemical functionalization step” is a dedicated step of treating the MFC (after the defibrillation step) with another reagent in a chemical reaction such that the MFC functional groups that are present before said chemical reaction (mostly —OH groups) are converted into different functional groups. Further preferably, the MFC has not been subjected to an oxidation reaction, a carboxylation reaction, a carboxymethylation reaction, a reaction of adding cationic functional groups, and a reaction of grafting a second polymer onto the MFC, after the defibrillation step.

Typically, the MFC may be uncrosslinked MFC. The MFC may not have been subjected to a crosslinking process.

The cellulose microfibrils may, in principle, also be modified by a physical route, either by adsorption at the surface, or by spraying, or by coating, or by encapsulation of the microfibril. Preferred modified microfibrils can be obtained by physical adsorption of at least one compound. The MFC may also be modified by association with an amphiphilic compound (surfactant). However, in preferred embodiments, the microfibrillated cellulose is not physically modified.

Without wishing to be bound by theory, it is believed that MFC is a highly efficient thickener in solvent systems, in particular water systems, and builds large three dimensional networks of fibrils which are stabilized by hydrogen bonds. The fibrils of MFC have hydroxyl groups on the surface that are fully dissociated (to form hydroxyl ions, O), at a high pH and cause intra and inter-particular interactions, stabilizing the overall network (stabilizing by “chemical” and/or “physical” interactions). In addition, MFC exerts high water holding capacity.

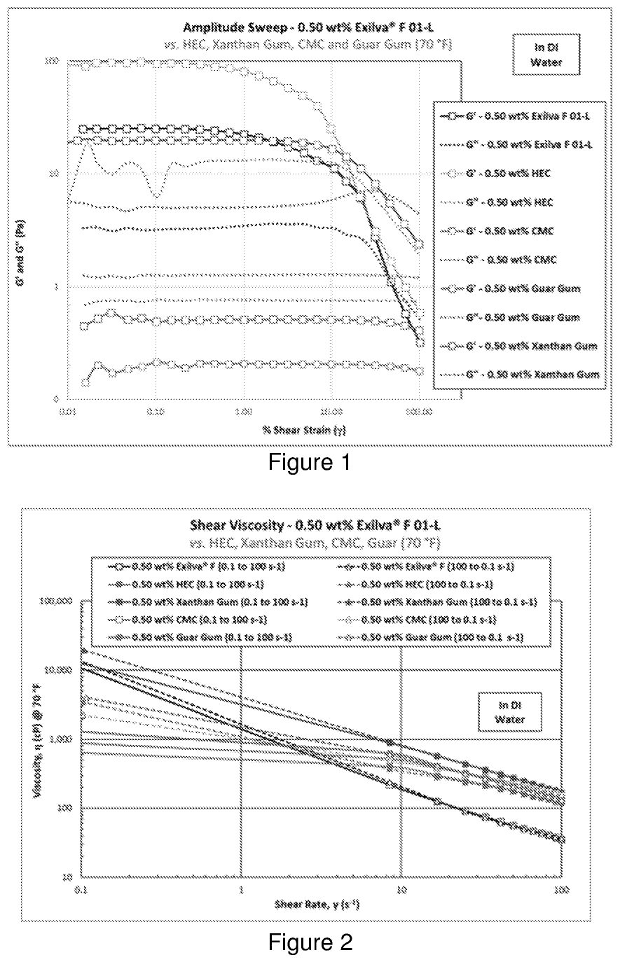

The dispersant, e.g. microfibrillated cellulose, may be a MFC product as marketed by Borregaard Chemicals Company under the trademark of Exilva™. This MFC has a greater storage capacity (Table 1 and FIG. 1) and greater slope of viscosity over shear rate (Table 2 and FIG. 2) as compared to common gelling agents.

More specifically, Table 1 and FIG. 1 show the results of an amplitude sweep test for 0.5 wt % Exilva™ MFC in tap water at ambient temperature, compared to the same amount of other cellulose or polysaccharide derivatives including HEC, CMC, guar gum and xanthan gum. In the amplitude sweep from 0 to 100%, the amplitude of the deformation is varied while the frequency is kept constant, and the storage modulus G′ and the loss modulus G″ are plotted against the deformation. In general, gelling agents are essentially polymeric materials with complex viscoelastic characteristics. At G′/G″ ratio of 1, it indicates an equal contribution by the storage (elastic) and loss (viscous) modulus respectively. MFC distinguishes itself against other common gelling agents with a significantly greater G′/G″ ratio, exhibiting superior elastic feature that is fundamental to its uniquely strong dispersing capability associated with this invention. In particular, the 3.5 (vs HEC) and 10.6 (vs CMC) folds increases in the G′/G″ ratio over two commonly used cellulose analogues demonstrate the distinctive feature of MFC material routed in its un-modified chemical nature and aspect ratio ranges.

TABLE 1

| Species | MFC | Xanthan | HEC | Guar | CMC |
|---|---|---|---|---|---|
| G′/G″ | 3.08 | 1.56 | 0.88 | 0.37 | 0.29 |

Table 2 and FIG. 2 show the results of a shear viscosity test for the same components as those of FIG. 1, depicting viscosity against shear rate where the slope of viscosity over shear rate is greatest for MFC compared to other common gelling agents. This is advantageous in providing a treatment composition, e.g. a stimulating composition, with beneficial shear thinning and fluid loss properties, amongst others.

TABLE 2

| Species | MFC | Xanthan | Guar | HEC | CMC |
|---|---|---|---|---|---|
| Slope | 7.14 | 3.22 | 2.04 | 1.92 | 1.64 |

A number of potential advantages of the present invention are discussed herein, although a person of skill in the art will appreciate that there may be others.

One advantage is that the present composition may be a shear thinning fluid (that is, the viscosity of the fluid decreases with rate of shear). This allows the treatment composition, e.g. stimulating fluid, to be pumped through the wellbore with little or no friction resistance, and while at slower pumping rates or near static conditions, the fluid exerts sufficient viscosity to preserve a single phase without undesirable phase separation.

Another potential advantage is that the composition may not leave undesirable residues in the formation as all additives are fully dispersible.

Another potential advantage of the composition is that it may exhibit beneficial fluid loss control. Such fluid loss control may be useful, among other instances, when an acidic treatment fluid is being used in a fracturing application, in particular where abundant natural fracture network exists. This may be due at least in part to the microcellulose fiber's potential to leak off into formation due to its superior shear thinning performances.

Another potential advantage may include ease of mixing over other commonly used gelling agents (thus avoiding lumping and thus not requiring pH adjustment for polymer dispersion), potential capability of dispersing in any brine over a wider range of PH levels, potential relative ease of additive hydration in the presence of certain common contaminants, potential capability of compatibility with formation brine (potentially saving time and cost), and potential ability to be directly blended into a mineral acid.

The composition may comprise or may further comprise a base fluid, preferably an aqueous base fluid. The base fluid may comprise fresh water, salt water, seawater, a brine (e.g., a saturated salt-water brine or a formation brine), or a combination thereof.

It will be understood that other aqueous fluids may be used as the base fluid, including aqueous solutions comprising monovalent, divalent, or trivalent cations (e.g., magnesium, calcium, zinc, or iron). If a water source is used that contains such divalent or trivalent cations in concentrations sufficiently high to be problematic, then such divalent or trivalent salts may be removed, for example by a process such as reverse osmosis, or by raising the pH of the water in order to precipitate out such divalent salts to lower the concentration of such salts in the water before the water is used. Another method may include adding a chelating agent to chemically bind the undesirable ions. Suitable chelants include, but are not limited to, citric acid or sodium citrate, ethylenediaminetetraacetic acid (“EDTA”), hydroxyethylethylenediaminetriacetic acid (“HEDTA”), dicarboxymethyl glutamic acid tetrasodium salt (“GLDA”), diethylenetriaminepentaacetic acid (“DTPA”), propylenediaminetetraacetic acid (“PDTA”), ethylenediaminedi (o-hydroxyphenylacetic) acid (“EDDHA”), glucoheptonic acid, gluconic acid, and the like, and nitrilotriacetic acid (“NTA”). Other chelating agents also may be suitable. One skilled in the art will readily recognize that an aqueous base fluid containing a high level of multi-valent ions should be tested for compatibility prior to use.

The choice of aqueous base fluid and acid may be selected vis-a-vis the other, among other reasons, so that the proper synergistic effect is achieved.

The composition may comprise one or more additives.

The composition may comprise a fluid loss additive. Whilst the inventors have discovered that the presence of microfibrillated cellulose in the composition may provide advantageous fluid loss properties to the composition, it may be desirable in some instances to include one or more fluid loss additives in order to fine tune the properties of the composition.

Advantageously, a fluid loss additive may be selected to be compatible with the composition, e.g. stimulation composition, of the present invention.

The fluid loss additive may comprise one or more compounds selected from the list consisting of starches, silica flour, and diesel dispersed in a fluid.

The fluid loss additive may comprise a degradable material, which may include one or more compounds, e.g. polymers, selected from the list consisting of polysaccharides such as dextran or cellulose; chitins; chitosans; proteins; aliphatic polyesters; poly(lactides); poly(glycolides); poly(glycolide-co-lactides); poly(ε-caprolactones); poly(3-hydroxybutyrates); poly(3-hydroxybutyrate-co-hydroxyvalerates); poly(anhydrides); aliphatic poly(carbonates); poly(orthoesters); poly(amino acids); poly(ethylene oxides); poly(phosphazenes); derivatives thereof; or combinations thereof.

The fluid loss additive may be present in the composition at a concentration of about 5 to 100 pounds per 1000 gallons, e.g. about 10 to about 50 pounds per 1000 gallons, of the composition.

As explained above, the use of microfibrillated cellulose may confer advantageous properties (described above in detail) to a treatment fluid for a wellbore, subterranean formation or reservoir. As such, there is provided a composition for treating a wellbore, subterranean formation or reservoir, the composition comprising:
a treatment fluid; and
a dispersant, wherein the dispersant comprises or consists of microfibrillated cellulose.

The compositions of the present invention may be useful in acid treatment such as acid stimulation. The compositions of the present invention may be useful in a wide variety of subterranean treatment operations in which acidic treatment fluids may be suitable. For example, an acidic treatment fluid of the present invention having a sufficient viscosity may be used to divert the flow of fluids present within a subterranean formation (e.g., formation fluids, other treatment fluids) to other portions of the formation, for example, by invading the higher permeability portions of the formation with a fluid that has high viscosity at low shear rates.

The methods and compositions of the present invention may be used during or in preparation for any subterranean operation wherein a fluid may be used. Suitable subterranean operations may include, but are not limited to, acidizing treatments (e.g., matrix acidizing or fracture acidizing), well bore clean-out treatments, and other suitable operations where a treatment fluid of the present invention may be useful.

### EXAMPLES

### Example 1: Retardation Test

Two ambient temperature, open systems tests were conducted to estimate at a semi-quantitative level the retardation factor of the modified acid fluids.

### Ingredients:

The acid was hydrochloric acid from VWR Chemicals;
The rate modulator was lignosulfonate (supplied by Borregaard);
The dispersant was microfibrillated cellulose as marketed by Borregaard Chemicals Company under the trademark of Exilva™

### 1(a) On Limestone Slab

On a slab of Indiana limestone featured with a permeability in the range of 9-16 mD, porosity approximately 15%, a droplet of ˜0.5 mL of 15% raw HCl, or modified acid of equivalent HCl concentration but with different loading levels of additives, was applied and the time lapse was counted till the acidic fluid was fully consumed. The results are presented in Table 3 below:

TABLE 3

| | | A | B | C | D | E |
|---|---|---|---|---|---|---|
| | | 15% HCl | 15% HCl | 15% HCl | 15% HCl | 15% HCl |
| | | 0.10% rate | 0.25% rate | 0.50% rate | 1.0% rate | 2.0% rate |
| | Control | modulator | modulator | modulator | modulator | modulator |
| Fluid | 15% | 0.2% | 0.2% | 0.2% | 0.2% | 0.2% |
| Composition | HCl | dispersant | dispersant | dispersant | dispersant | dispersant |
| Time Lapse/S | 20 | 180 | 600 | 1020 | 1440 | 1920 |
| Retardation | 1 | 9 | 30 | 51 | 72 | 96 |
| Factor | | | | | | |

An additional series of test were conducted on Indiana limestone slab of identical specs using a mixture of 15% raw HCl and various concentrations of dispersant, with the results shown in Table 3a below:

TABLE 3a

| | | A | B | C | D |
|---|---|---|---|---|---|
| | Control | 15% HCl | 15% HCl | 15% HCl | 15% HCl |
| Fluid | 15% | 0.2% | 0.5% | 0.75% | 1.0% |
| Composition | HCl | dispersant | dispersant | dispersant | dispersant |
| Time Lapse/S | 20 | 60 | 145 | 200 | 320 |
| Retardation | 1 | 3 | 7 | 10 | 16 |
| Factor | | | | | |

### 1(b) Using Calcium Carbonate Powders

2 g of calcium carbonate powder (SigmaAldrich, ACS grade) was placed at the bottom of a 500 mL measuring cylinder. Next, the stoichiometric amount of 15% HCl either raw or modified at equivalent concentration, was added under moderate agitation by a magnetic stirring bar, while the time lapse was counted till the reaction was complete as evident by the disappearance of the CO₂ gas bubbles. The modified HCl was added in a dropwise mode in order to minimize the error caused by two possible issues:
i. Floating of part of the calcium carbonate reactant to the top of the CO₂ foams along the cylinder wall.
ii. Calcium carbonate powders aggregating into a domain, the inside of which is temporarily shielded from the acidic fluid

The results are presented in Table 4 below:

TABLE 4

| | | A | B | C | D | E |
|---|---|---|---|---|---|---|
| | | 15% HCl | 15% HCl | 15% HCl | 15% HCl | 15% HCl |
| | | 0.10% rate | 0.25% rate | 0.50% rate | 1.0% rate | 2.0% rate |
| | Control | modulator | modulator | modulator | modulator | modulator |
| Fluid | 15% | 0.2% | 0.2% | 0.2% | 0.2% | 0.2% |
| Composition | HCl | dispersant | dispersant | dispersant | dispersant | dispersant |
| Time Lapse/S | 20 | 190 | 610 | 1000 | 1480 | 1830 |
| Retardation | 1 | 9 | 30 | 50 | 74 | 97 |
| Factor | | | | | | |

An additional series of test were conducted on calcium carbonate powder of identical specs using a mixture of 15% raw HCl and various concentrations of dispersant, with the results shown in Table 4a below:

TABLE 4a

| | | A | B | C | D |
|---|---|---|---|---|---|
| | Control | 15% HCl | 15% HCl | 15% HCl | 15% HCl |
| Fluid | 15% | 0.2% | 0.5% | 0.75% | 1.0% |
| Composition | HCl | dispersant | dispersant | dispersant | dispersant |
| Time Lapse/S | 20 | 70 | 160 | 210 | 330 |
| Retardation | 1 | 3 | 8 | 10 | 17 |
| Factor | | | | | |

It can be seen that, on both substrates, the addition of lignosulfonate as rate modulator and microfibrillated cellulose as dispersant, to HCl, greatly delays the reaction of the acid with the substrate material. The degree of retardation also increased with an increase in the concentration of lignosulfonate.

### Example 2: Stability Test

The fully loaded acidizing fluid with different amounts of additives were placed at two temperature levels for observation of any phase change over time

The results are presented in Table 5 below:

TABLE 5

| | 15% HCl | 15% HCl | 15% HCl |
|---|---|---|---|
| | 0.10% rate | 0.50% rate | 2.0% rate |
| | modulator | modulator | modulator |
| Fluid | 0.2% | 0.2% | 0.2% |
| composition | dispersant | dispersant | dispersant |
| 73° F. hood | >14 days | >14 days | >14 days |
| 150° F. oven | >3 days | >3 days | >3 days |

### Example 3: Suppression of HCl Fumes

A strip of gently moisturized Hydrion litmus paper (from Micro Essential Laboratory Inc) in the headspace of a storage fluid container.

The results are presented in Table 6 below:

TABLE 6

| Fluid | Observation |
|---|---|
| 15% Raw HCl | Coloration from the original orange |
| | to full red within 1 second |
| 15% HCl | Gradual coloration from the |
| 0.5% Rate modulator | original orange to full |
| 0.2% dispersant | red took approx. 140 seconds |

The sluggish process of coloration for the modified acid composition indicates significantly suppressed partial vapor pressure of acid proton in the gas phase as a result of the effective binding between acid proton and the additive ligands that reduces the proton mobility, and in turn its abundance in the gas phase.

### Example 4: Compatibility Test

Acidizing fluids were provided in the presence of a corrosion inhibitor.

Observations are presented in Table 7 below:

TABLE 7

| | 15% HCl | 15% HCl | 15% HCl |
|---|---|---|---|
| | 0.10% rate | 0.50% rate | 2.0% rate |
| Fluid | modulator | modulator | modulator |
| composition | 0.2% dispersant | 0.2% dispersant | 0.2% dispersant |
| +1.0 wt % COR | 2 days | 2 days | 2 days |
| 1011 corrosion | | | |
| inhibitor | | | |
| (Shrieve) | | | |

The core parameter for observation in compatibility test is whether or not the component(s) start to phase separate, typically forming precipitates in large quantities. In most of the cases, all the components in the presence of corrosion inhibitor remained homogeneous for a period of 48 hours satisfies the requirements of both onshore and offshore jobs.

### Example 5: Corrosion Inhibition Performance Test

Metal coupons were submerged in acidizing fluid (15% HCl/0.50% rate modulator/0.2% dispersant/2% corrosion inhibitor COR1011, Shrieve) at 250° F. for 6 hrs using common metallurgies P110 and N80. Each rectangular coupon has a surface area of 3.38 in² (=0.02347 ft²)

TABLE 8

| | | | | Corrosion |
|---|---|---|---|---|
| Metallurgy | Start mass/g | Final mass/g | Δmass/g | rate lb/ft² |
| P110A | 11.6429 | 11.1014 | 0.5415 | 0.050 |
| P110B | 11.6075 | 11.0675 | 0.5400 | 0.049 |
| N80A | 14.7390 | 14.2982 | 0.4408 | 0.041 |
| N80B | 14.6915 | 14.2514 | 0.4401 | 0.041 |

It can be seen that modified acid contributed to reduce the corrosion rate. Raw HCl of the same concentration would have to require at least +50% corrosion inhibitor loading (typically the most expensive additive in acidizing fluid composition) to achieve the same level of corrosion inhibition. In the absence of the modification ligands as shown in the disclosure, raw HCl with the same corrosion inhibitor loading would result in corrosion rates in the range of 0.1 lb/ft², failing to meet the generic requirement.

### Example 6: Coreflood Tests

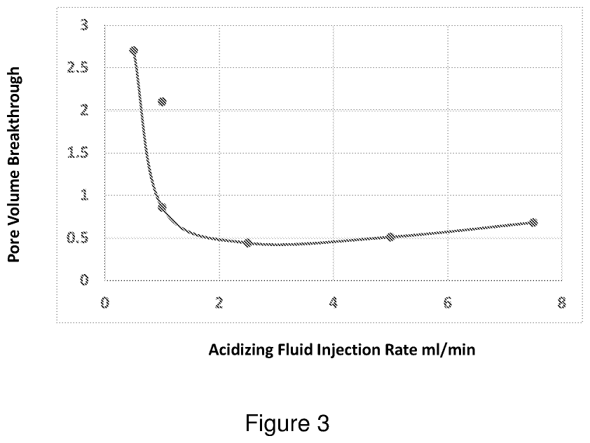

Coreflood tests were conducted at 250° F. on a Chandler Engineering Model 6100 Formation Response Tester, using a cylindric Indiana Limestone core of 6″×1.5″, permeability 11 mD, porosity 25%, obtained from Kocurek Industries. Pumping rates between 0.5 ml/min to 7.5 ml/min were applied, with back pressure at the bottom of the core 1100 psi, confining pressure on rubber sleeve 1800 psi. The results are summarized in Table 9 below. The calcium concentration in the effluent was measured on an inductively coupled plasma instrument. The results show that the modified acid formulation as disclosed in the invention is significantly more effective in penetrating the formation, which is highly desirable for the perceived treatment. In the meantime, the correspondingly lower calcium concentration in the effluent associated with optimal injection rate range also contributes to the overall job performance with less burden on spent acid fluid handling. The pore volume breakthrough-injection rate correlation is plotted in FIG. 3, showing the optimal injection rate for the particular conditions, i.e. core type, permeability and testing temperature, is around 2.5 ml/min for the acidizing fluid composition as disclosed in this invention.

TABLE 9

| | Injection | Pore volume | Cumulative |
|---|---|---|---|
| Fluid Composition | Rate ml/min | breakthrough | Calcium/mg |
| 15% HCl/0.25% rate | 0.5 | 2.7 | 2596 |
| modulator/0.2% dispersant | | | |
| 15% HCl | 1.0 | 2.1 | 1940 |
| 15% HCl/0.25% rate | 1.0 | 0.85 | 870 |
| modulator/0.2% dispersant | | | |
| 15% HCl/0.25% rate | 2.5 | 0.44 | 398 |
| modulator/0.2% dispersant | | | |
| 15% HCl/0.25% rate | 5.0 | 0.56 | 475 |
| modulator/0.2% dispersant | | | |
| 15% HCl/0.25% rate | 7.5 | 0.92 | 894 |
| modulator/0.2% dispersant | | | |

It will be appreciated that the described embodiments are not meant to limit the scope of the present invention, and the present invention may be implemented using variations of the described examples.

1. A composition for stimulating a wellbore, subterranean formation or reservoir, the composition comprising:
a stimulating fluid;
a rate modulator configured to reduce or decrease the rate of reaction between the stimulating fluid and the wellbore, subterranean formation or reservoir; and
a dispersant, wherein the dispersant comprises or consists of microfibrillated cellulose (MFC).

2. A composition according to claim 1, wherein the stimulating fluid comprises or consists of an acid.

3. A composition according to claim 2, wherein the acid comprises or consists of a mineral acid.

4. A composition according to claim 2, wherein the acid comprises or consists of hydrochloric acid (HCl) and/or hydrofluoric acid (HF).

5. A composition according to claim 1, wherein the rate modulator comprises or consists of a lignosulfonate or a modified lignosulfonate.

6. A composition according to claim 1, wherein the rate modulator also functions to scavenge hydrogen sulfide and/or mercaptan contained in the formation fluid.

7. A composition according to claim 1, wherein the rate modulator is present at a concentration of about 0.01-90 wt %, optionally about 0.05-50 wt %, optionally about 0.1-25 wt %, based on the total weight of the composition.

8. A composition according to claim 1, wherein the MFC fibers or fibrils have one or more of the following dimensions:
(i) a diameter of about 0.1-100 nm;
(ii) a length of about 1-100 μm; and
(iii) a length to diameter ratio of about 10 to 10,000.

9. A composition according to claim 1, wherein the dispersant is present at a concentration of about 0.01-2 wt %, optionally about 0.05-1 wt %, optionally about 0.1-0.5 wt %, based on the total weight of the composition.

10. A composition according to claim 1, further comprising an aqueous base fluid.

11. A composition according to claim 1, further comprising a fluid loss additive.

12. A composition for stimulating a wellbore, subterranean formation or reservoir, the composition comprising:
an stimulating fluid, wherein the stimulating fluid comprises or consists of an acid;
a rate modulator, wherein the rate modulator comprises or consists of a lignosulfonate or a modified lignosulfonate; and
a dispersant, wherein the dispersant comprises or consists of microfibrillated cellulose.

13. A composition for treating a wellbore, subterranean formation or reservoir, the composition comprising:
a treatment fluid; and
a dispersant, wherein the dispersant comprises or consists of microfibrillated cellulose.

14. A composition according to claim 13, wherein the treatment fluid is a stimulation fluid.

15. A composition according to claim 13, wherein the treatment fluid comprises an acid.

16. A composition according to claim 13, further comprising a rate modulator configured to reduce or decrease the rate of reaction between the treatment fluid and the wellbore, subterranean formation or reservoir.

17. A composition according to claim 16, wherein the rate modulator comprises or consists of a lignosulfonate or a modified lignosulfonate.

18. A method of treating a wellbore, subterranean formation or reservoir, the method comprising injecting in the wellbore, subterranean formation or reservoir a composition according to claim 1.

19. A method according to claim 18, comprising performing acid stimulation of the wellbore, subterranean formation or reservoir.

20. (canceled)

21. A method according to claim 19, comprising stimulating the wellbore, subterranean formation or reservoir by dissolving filter cake and/or gravel packing.
